(19) United States
(12) Patent Application Publication
(10) Pub. No.: US 2025/0159030 A1
(43) Pub. Date: May 15, 2025

(54) TERMINAL, METHOD AND COMPUTER PROGRAM

(71) Applicant: 17LIVE Japan INC., Tokyo (JP)

(72) Inventors: Chieh-Neng CHUANG, Taipei City (TW); Yu-Cheng FAN, Taipei City (TW); Hao-Chia CHUNG, Taipei City (TW); Sheng-Chuan HSU, Taipei City (TW)

(21) Appl. No.: 18/947,854

(22) Filed: Nov. 14, 2024

(30) Foreign Application Priority Data
Nov. 15, 2023 (JP) 2023-194765

(51) Int. Cl. H04L 65/60; H04N 21/238; H04N 21/472

(52) U.S. Cl. CPC H04L 65/60; H04N 21/238; H04N 21/472

(57) ABSTRACT

A terminal for displaying animation in a live streaming room, comprising one or a plurality of processors, wherein the one or plurality of processors execute a machine-readable instruction to perform: generating a Web View object on a screen; setting an animation player for displaying an animation in the Web View object, providing the animation player with an animation resource; and displaying an effect of the animation resource via the animation player. According to the present disclosure, the media components may be initialized dynamically and a systematic way of conducting media resources through the web may also be realized. Therefore, the user experience may be improved.

### CROSS-REFERENCE TO RELATED APPLICATIONS

This application is based on and claims the benefit of priority from Japanese Patent Application Serial No. 2023-194765 (filed on Nov. 15, 2023), the contents of which are hereby incorporated by reference in their entirety.

### BACKGROUND OF THE DISCLOSURE

### Technical Field

This disclosure relates to information and communication technology, and in particular, to a terminal, method and computer program in a live streaming.

### Description of the Related Art

Current process to release a new application version to the users is complex and time-consuming, requiring multiple steps before the actual release. Even simple changes are required to run through the process, take animation as example, from animation resource update to the player feature or bug fix are all required to run the release process.

Moreover, current animation playback on mobile devices typically involves accessing large amounts of files in order to create rich and engaging content for the users. However, this often leads to a significant increase in the storage space required for these files, thereby limiting the available storage space for other applications and files.

In order to play animations, the native way would require a static implementation, which is to implement media related libraries in the code, and compiled along with the application. Combining the problem which the invention is trying to solve the current method, even if animation resources could be downloaded after compiling, but the player itself is incompetent in this matter.
[Patent Document 1]: CN107092468A

### SUMMARY OF THE DISCLOSURE

An embodiment of subject application relates to a terminal for displaying animation in a live streaming room, comprising one or a plurality of processors, wherein the one or plurality of processors execute a machine-readable instruction to perform: generating a Web View object on a screen; setting an animation player for displaying an animation in the Web View object; providing the animation player with a animation resource; and displaying an effect of the animation resource via the animation player.

Another embodiment of subject application relates to a method for displaying animation in a live streaming room, comprising: generating a Web View object on a screen; setting an animation player for displaying an animation in the Web View object; providing the animation player with a animation resource; and displaying an effect of the animation resource via the animation player.

Another embodiment of subject application relates to a computer program for causing a terminal to realize the functions of: generating a Web View object on a screen; setting an animation player for displaying an animation in the Web View object; providing the animation player with a animation resource; and displaying an effect of the animation resource via the animation player.

According to the present disclosure, the media components may be initialized dynamically and a systematic way of conducting media resources through the web may also be realized. Moreover, updating the framework/media component to the user's local device may be bypassed from time consuming platform application processes. Therefore, the user experience may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the player DB 324 of FIG. 3;

FIG. 7 shows an exemplary data structure of the gift DB 326 of FIG. 3;

FIG. 8 shows an exemplary data structure of the terminal side player DB 210 of FIG. 2;

FIG. 9 shows an exemplary data structure of the terminal side gift DB 212 of FIG. 2;

FIG. 10 is exemplary functional configuration of the user terminal 20 or user terminal 30 according to some embodiments of subject application;

FIG. 11 and FIG. 15 are exemplary screen images of a live-streaming room screen 600 shown on the display of the livestreamer user terminal 20 or the viewer user terminal 30;

FIG. 16 is a flowchart showing steps of an application activation process on the user terminals 20 and 30;

FIG. 17 is an exemplary sequence chart illustrating an operation of the configuration of the live streaming system 1 according to some embodiments of subject application;

FIG. 18 is an exemplary hardware configuration of the information processing device 900 according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and livestreamers in a technical way.

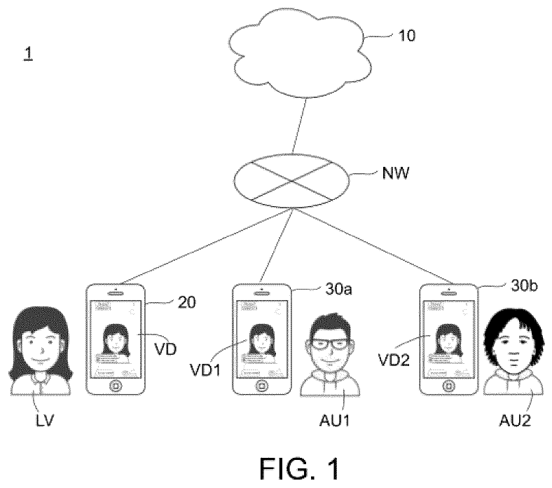

FIG. 1 shows a schematic configuration of a live streaming system 1 according to some embodiments of subject application. The live streaming system 1 provides a live streaming service for the streaming livestreamer (may also be referred as liver, streamer or distributor) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a livestreamer and the user terminal 30 may be a viewer. In some embodiments, the livestreamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the livestreamer LV, the viewer AU, and APP provider (not shown), who provides the server 10. The livestreamer LV may record his/her own contents such as songs, talks, performance, game streaming or the like by his/her own user terminal 20 and upload to the server 10 and be the one who distributes contents in real time. In some embodiments, the livestreamer LV may interact with the viewer AU via the live streaming.

The APP provider may provide a platform for the contents to go on live streaming in the server 10. In some embodiments, the APP provider may be the media or manager to manage the real time communication between the livestreamer LV and viewer AU. The viewer AU may access the platform by the user terminal 30 to select and watch the contents he/she would like to watch. The viewer AU may perform operations to interact with the livestreamer, such as commenting or cheering the livestreamer, by the user terminal 30. The livestreamer, who provides the contents, may respond to the comment or cheer. The response of the livestreamer may be transmitted to the viewer AU by video and/or audio or the like. Therefore, a mutual communication among the livestreamer and viewer may be accomplished.

The “live streaming” in this specification may be referred to as the data transmission which enables the contents the livestreamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the livestreamer is recording the contents. Regarding the magnitude of the delay, it should be at least small enough to enable the livestreamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 and 30, so that the contents relating to users may be available for watching. In some embodiments, during the period from the streaming data being generated by the user terminal 20 of the livestreamer to being reproduced by the user terminal 30 of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal 20 of the livestreamer and reproduced by the user terminal 30 of the viewer via the server 10, the streaming data generated by the user terminal 20 of the livestreamer, the streaming data passed through the server 10 and the streaming data received and reproduced by the by the user terminal 30 of the viewer are all the same streaming data.

As shown in FIG. 1, the livestreamer LV is providing the live streaming. The user terminal 20 of the livestreamer generates the streaming data by recording his/her video and/or audio, and transmits to the server 10 via the network NW. At the same time, the user terminal 20 may display the video VD on the display of the user terminal 20 to check the streaming contents of the livestreamer LV.

The viewer AU1, AU2 of the user terminal 30a, 30b, who request the platform to provide the live streaming of the livestreamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal 20 of the livestreamer LV, and the audio outputted from the terminal 30a, 30b may also be substantially the same as the audio recorded by the user terminal 20 of the livestreamer LV.

The recording at the user terminal 20 of the livestreamer may be simultaneous with the reproducing of the streaming data at the user terminal 30a, 30b of the viewer AU1, AU2. If a viewer AU1 inputs a comment on the contents of the livestreamer LV into the user terminal 30a, the server 10 will display the comment on the user terminal 20 of the livestreamer in real time, and also display on the user terminal 30a, 30b of the viewer AU1, AU2 respectively. If the livestreamer LV responds to the comment, the response may be outputted as the text, image, in video or audio from the terminal 30a, 30b of the viewer AU1, AU2, so that the communication of the livestreamer LV and viewer LV may be realized. Therefore, the live streaming system may realize the live streaming of two-way communication.

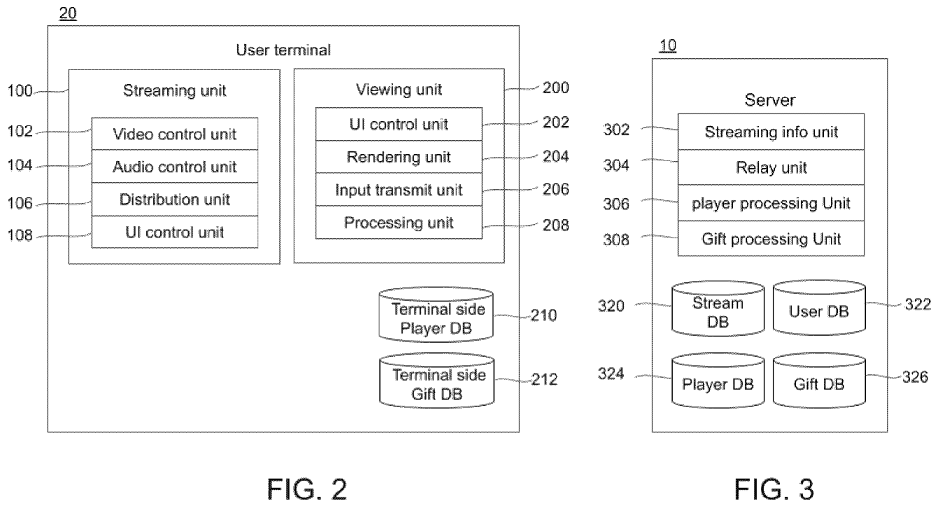

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The livestreamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal 20 who is activating the streaming unit 100 may be referred to as a livestreamer or be referred to as the user terminal which generates the streaming data. The user terminal 30 who is activating the viewing unit 200 may be referred to as a viewer or be referred to as the user terminal 30 which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the livestreamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the livestreamer.

The viewing unit 200 may include UI control unit 202, rendering unit 204, input transmit unit 206 and processing unit 208. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal 20 such as selecting a live stream, entering a comment, sending a gift, following or unfollowing a user, voting in an event, gaming or the like. For example, the input transmit unit 206 may generate gift information and transmit to server 10 via the internet NW if the user terminal 30 of the viewer clicks a gift object on the screen in order to send a gift to the livestreamer.

The processing unit 208 is configured to display video or audio on the user terminal 20. In some embodiments, the processing unit 208 may display the effect of the gift on the screen of the user terminal 20 once the viewer sent the gift or the livestreamer received the gift. In some embodiments, the processing unit 208 may generate an object such as a browser to display the effect. In some embodiments, the browser may be a Web View object generated and located on a screen of the user terminal 20.

In some embodiments, an animation player may further be set in the Web View object to display effects of the gift. In some embodiments, the animation player may be online or downloaded in the user terminal 20 to display effects of the gift. In some embodiments, the animation player may be a video player embedded in the Web View for displaying the effect. In some embodiments, the animation player may be any available video player such as html video player, media player or the like.

In some embodiments, the effect of the gift may be any possible multimedia-related content such as an image, text, video, audio or the like. The effect of the gift may be .png, .mp4, pag, or WebP in format or the like. In some embodiments, the animation player may include different types of encoders and decoders for display animation in different formats.

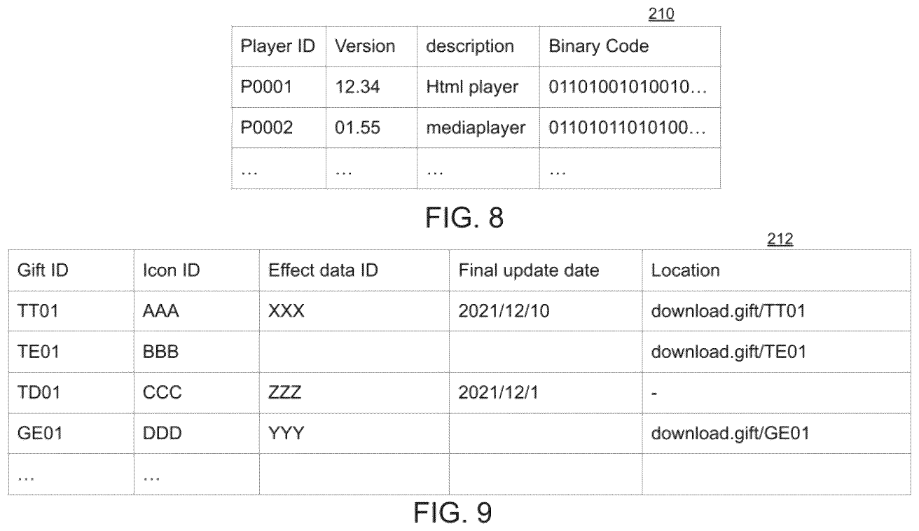

FIG. 8 shows an exemplary data structure of the terminal side player DB 210 of FIG. 2. The terminal side player DB 210 is configured to store the information of the video player in the user terminal 20 or 30. The terminal side player DB 210 may include player ID, version information, description, binary code or the like, in association with each other. The player ID may identify the video player. The version information may be the version of the video player. The description may identify a description of the video player. The binary code may identify binary code corresponding to the video player.

FIG. 9 shows an exemplary data structure of the terminal side gift DB 212 of FIG. 2. The terminal side gift DB 212 is configured to store the gift information of the user terminal 20 or 30. The terminal side gift DB 212 may include gift ID, icon ID, effect data ID, final update date, location or the like, in association with each other. The gift ID may identify the gift. The Icon ID may be the icon data of the gift object. The effect data ID may identify the data realizing the effect corresponding to the gift. The final update date may identify the final update date of the gift. The location may identify the location of the effects in the user terminal.

A gift is electronic data with the following characteristics:
It can be purchased in exchange for the points (later described in detail) or can be given for free.
It can be given by a viewer to a livestreamer. —Giving a gift to a livestreamer is referred to as using the gift or throwing the gift.
Some gifts may be purchased and used at the same time, and some gifts may be purchased or given and then used at any time later by the purchaser or recipient viewer.
When a viewer gives a gift to a livestreamer, the livestreamer is awarded the amount of points corresponding to the gift and an effect associated with the gift is exerted. For example, an effect corresponding to the gift will appear on the live-streaming screen.

The effect is a visual or auditory or tactile effect (e.g., vibration) or a combination thereof that characterizes a gift. Examples of the visual effect include animation, images, and flashing/blinking. Examples of the auditory effect include sound effects and voice. The effect data is data for realizing such an effect on the user terminal 20, and the user terminal 20 realizes such an effect by processing the effect data. Since the technique for realizing the effect data itself is known, it will not be hereunder described in detail.

FIG. 3 is a schematic block diagram of the server 10 according to some embodiments of the subject application. The server 10 may include streaming info unit 302, relay unit 304, player processing unit 306, gift processing unit 308, stream DB 320, user DB 322, player DB 324 and gift DB 326.

The streaming info unit 302 receives the request of live streaming from the user terminal 20 of the livestreamer via the network NW. Once receiving the request, the streaming info unit 302 registers the information of the live streaming on the stream DB 320. In some embodiments, the information of the live streaming may be the stream ID of the live streaming and/or the livestreamer ID of the livestreamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming. The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the livestreamer ID of the stream ID.

The relay unit 304 may relay the transmission of the live streaming from the user terminal 20 of the livestreamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30.

The object-designated signal may include the viewer ID of the viewer, the livestreamer ID of the livestreamer, who delivers the live streaming the viewer is viewing, and object ID specified by the object. If the object is a gift or the like, the object ID may be the gift ID or the like. Similarly, the relay unit 304 may receive the signal indicating the user input of the livestreamer, for example the object-designated signal, from the streaming unit 100 of the user terminal 20 while the streaming data is reproducing.

The player processing unit 306 is configured to provide information on the animation player to the corresponding livestreamer and viewers. The player processing unit 306 transmits information of the animation player to the user terminal voluntarily or in response to an update request from the user terminals 20 and 30 of the users. The player processing unit 306 obtains, from the player DB 324, the information of the animation player and transmits the obtained information to the user terminals 20 and 30 voluntarily or as a response to the update request signal from the user terminal.

The gift processing unit 308 provides information on gifts to the corresponding livestreamer and viewers. The gift processing unit 308 transmits, to the livestreamer, the gift information for the terminal in response to a request from the user terminals 20 and 30. The gift processing unit 308 obtains, from the gift DB 326, the effect data corresponding to the gift ID included in the gift information signal that has been received by the relay unit 304. The gift processing unit 308 transmits the obtained effect data to the other user terminals 20 and 30 as a response to the gift sending request signal.

The gift processing unit 308 further updates the user DB 322 so as to update the points of the livestreamer and the viewer depending on the points of the gift identified by the gift ID included in the gift usage signal. Specifically, the gift processing unit 308 refers to the gift DB 326 to specify the points to be granted for the gift ID included in the received gift usage signal. The gift processing unit 308 then updates the user DB 322 to add the determined points to the points of the livestreamer ID included in the gift usage signal. In some embodiments, the gift processing unit 308 may also update the user DB 322 to subtract the determined points from the points of the viewer ID included in the gift usage signal.

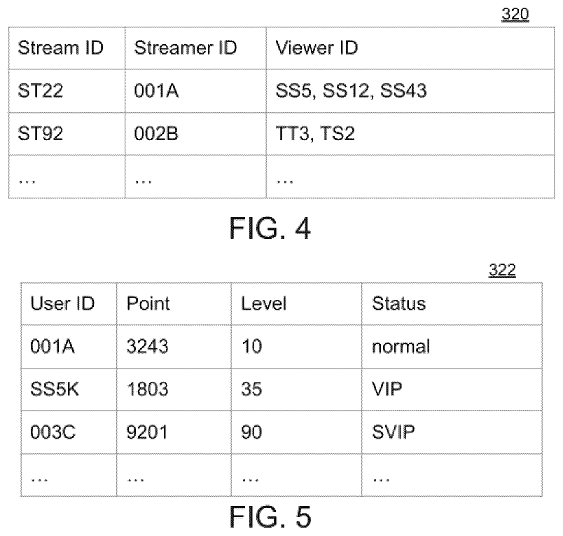

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live streaming system 1, a livestreamer ID for identifying the livestreamer who provides the live-stream, and a viewer ID for identifying a viewer of the live-stream, in association with each other.

FIG. 5 shows an exemplary data structure of the user DB 322 of FIG. 3. The user DB 322 holds information regarding users. The user DB 322 stores a user ID for identifying a user, points for identifying the points the user accumulates, level for identifying the level of the user and status for identifying the status of the user in association with each other. The point is the electronic value circulated within the live-streaming platform. The level may be an indicator of the amount of user activity or engagement on the live streaming platform. The status may be an identity or membership status of the user on the live streaming platform.

FIG. 6 shows an exemplary data structure of the player DB 324 of FIG. 3. The player DB 324 holds information regarding a video player which is available on the live distribution platform. The player DB 324 stores a player ID for identifying a video player in the live streaming system 1, a version info for identifying version of the video player, a description for identifying a description of the video player, a binary code for identifying binary code of the video player, in association with each other. In some embodiments, the video player may be converted into binary code in the server 10 or user terminals 20 and 30.

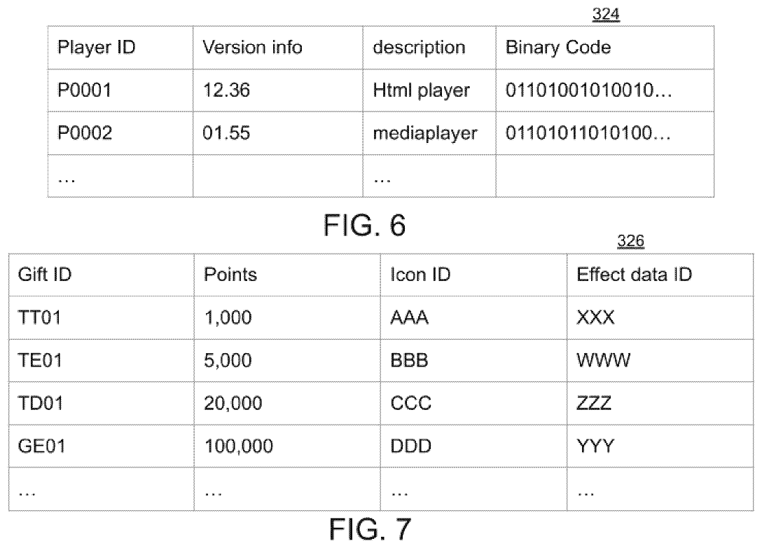

FIG. 7 shows an exemplary data structure of the gift DB 326 of FIG. 3. The gift DB 326 stores information of the gifts in the live streaming system 1. The gift DB 326 stores a gift ID for identifying a gift, the amount of points that are granted to a livestreamer when the gift is given to the livestreamer, the icon data for the gift, and the effect data for the gift, in association with each other.

In some embodiments, once the viewer launched the app, entered a live streaming room, triggered an animation such as opening a gift page or sending a gift, the processing unit 208 may activate a video player on screen of the user terminal. In some embodiments, the processing unit 208 may generate a WebView object on screen of the user terminal. Furthermore, an animation player, such as the html video player, may be set on the Web View object for displaying the effect of the gift resource.

In some embodiments, the information of the video player may be received from the server 10 or other resources via the internet. In some embodiments, the server 10 may provide the user terminal with information about the video player in the format of binary code or the like. In some embodiments, the processing unit 208 may receive binary code of the video player and feed the binary code into the Web View object to build the animation player in the Web View object. In some embodiments, the processing unit 208 may request the installation file of the animation player and further convert it into binary code to be stored in the user terminal.

In some embodiments, the processing unit 208 may further determine the version of the video player on the user terminal. For example, once the html video player is set in the user terminal, the processing unit 208 may confirm whether the current animation player is the latest or not. If the animation player is not the latest one, the processing unit 208 may retrieve the latest html video player from the server 10 to replace with the current one and regenerate the animation player when necessary. In some embodiments, timing for determining the update may also be when a user enters a live streaming room, when a Web View object is generated, when the user sends a gift to a livestreamer or the like.

In some embodiments, the processing unit 208 may determine whether to update the video player by comparing the binary code. If the video player is set at the first time, the processing unit 208 may retrieve the binary code and set it in the Web View object. If not the first time, the processing unit 208 may retrieve the binary code from the server 10 and the binary code may include information such as version of the latest video player, request of updating the video player or the like. According to the embodiments, the update of the animation player may be informed purely via the communication between the user terminal and the server 10 without the procedure of relaunching or reconfiguration of the application. Therefore, the efficiency of the video player may also be improved.

In some embodiments, the processing unit 208 may determine the update by checking whether the video player is the latest version or not. In some embodiments, the processing unit 208 may determine the update by checking whether the video player is an acceptable version or not. In some embodiments, the processing unit 208 may determine the update by checking parameters such as MD5 (Message-Digest Algorithm 5) or the like. In some embodiments, the update of the video player may be determined flexibly according to the practical need.

Once the video player is set, the animation resource such as the effect of gifts may be played via the video player. In some embodiments, the effect of the gift may be the URL indicating location of the effects. Once the URL is fed to the Web View object, data related to the effect may be requested from the server 10 or the like. In some embodiments, the data may be html object, JS object, CSS object or the like.

In some embodiments, the requested data may also be cached in the webpage. For example, the effect of the gift may be stored as a URL in the server 10 and played via the video player in the Web View object. Instead of the URL, the effect of the gift may also be requested as the files with multimedia-related content. More specifically, the file of effect may be requested via API and stored in the user terminal, so the multimedia-related content may be stored in a local space of the user terminal and played in the user terminal.

Both the above methods have advantages and disadvantages. Web retrieves resources over the internet and does not incorporate a database component. When a user requests content via the user terminal, the resources required to be displayed must be downloaded first. In some embodiments, the website may be loaded via the application's native library, Web View, using a URL, representing an online version of the animation display. Due to the animation resource files requiring continuous downloading, they are not included in the application package.

Before playing an animation, the play function provided by the website must be called, along with the animation file, animation URL, or other means of retrieving animation resources. Once the file has been downloaded and read, the website begins playing the animation. After completion of the animation playback, the application is notified via a callback sent from the website, enabling the next animation to be played.

To avoid repeated download sequences, the web utilizes cache mechanisms. Nevertheless, device memory limitations can lead to resource depletion and the need for re-downloading. To address this issue, the following embodiments may also be considered.

The website may be loaded via the application's native library, Web View, utilizing HTML, representing an offline version of the animation display where the animation files are not required to be downloaded. To play an animation, the play function provided by the website must be called, along with the animation file or other forms of animation resources. Upon reading the file, the website automatically starts playing the animation. After playback completion, the application is notified via a callback that enables the next animation to be played.

Since loading HTML files are considered static, it will need to be updated for newer versions. The update scheme is checking for its version before the player is initialized. Through network connection, backend services, cloud services, or any form of network services is carried out to confirm whether it is the latest version. If not, the new version will be updated before the player is initialized.

The way for displaying animation via URL link is dynamic. The mechanism of animation display via URL may be updated to the latest version automatically. The gift resource may be downloaded repeatedly and cached in the webpage of the Web View object. However, the cache has a maximum capacity and old cache will be deleted when the cache capacity reaches its limit. Moreover, the animation display via URL may only be available with the internet connection.

In contrast, the way for displaying animation via loading HTML files is static. The update mechanism of the video player is necessary, but the update is only necessary when bugs need to be fixed or new features need to be applied. The gift resource may be downloaded and stored in local storage space in the user terminal. The gift resource would not be deleted if the storage is enough. Therefore, repeated downloading of the gift resource is not necessary. Moreover, the animation display via the html video player may be available even if there is no internet connection.

One difference between the above mechanism is repeated downloading of the gift resource. More specifically, if the effect of gift is played via the URL, the cache may be stored in the webpage. Once the gift is requested again, the processing unit 208 may refer to the cache data for display. However, the cache in a web page is limited, there is no guarantee that the cache may be retrieved successfully. If there is no cache available, the gift resource would be downloaded again.

One advantage of displaying an effect with the html video player and the gift resource is that the video player and multimedia-related files may be loaded and played in the local user terminal. In other words, once the video player is set and the multimedia-related files are stored, the procedure of re-downloading may be skipped. According to the embodiments, the advantage of HTML playback is that it loads animations from the local end, eliminating download issues. Content that has been loaded locally will be stored in the local terminal, not on the webpage cache, thus avoiding the limitations mentioned above. Therefore, the quality of playing effect on the user terminal may be improved.

In some embodiments, once an effect is about to be played, a Web View object may be generated. Instead of displaying web contents, the video player may be established via the binary code. Once the video player is established, it may be operated even if there are no internet connections. Moreover, once an effect of the gift is downloaded or played, it may be replayed again even if there are no internet connections. In other words, the user terminal may be used as a storage for the effects of gifts. Once the same gift is sent, the stored gift resource may be used again for displaying the effect. According to the embodiments, the quality of displaying effects may be improved.

Another advantage of displaying an effect via a Web View object is that it may be applied to different platforms easily. One way of establishing a video player in an APP is to, for example, establish a code in the program of the APP, which is a static way to establish the video player. However, there are different operating systems such as Android, IOS, website or the like.

Once a fix or update is performed, the code needs to be re-programmed and a configuration of updating the version of APP is necessary. Moreover, the development of different operating systems or platforms may require human resources specialized in different platforms, which may cause the waste of time and effort.

In contrast, generating a Web View as a web page to run the gift resource may be applied among different operating systems or platforms. Since the display of html-related contents via web page may be applied to different platforms such as iOS, Android or the like without extra efforts, the above embodiments may be applied to different platforms without further development concern.

Moreover, the video player may be downloaded and stored in the format of binary code, even if the user terminals of the users are from different platforms, they may build a video player via the binary code. Once the binary code is stored, the video player may also be updated or played according to the binary code online and even offline. Therefore, the concern of development in different platforms may be addressed and the time to deliver new features and player-related content to the users may be faster.

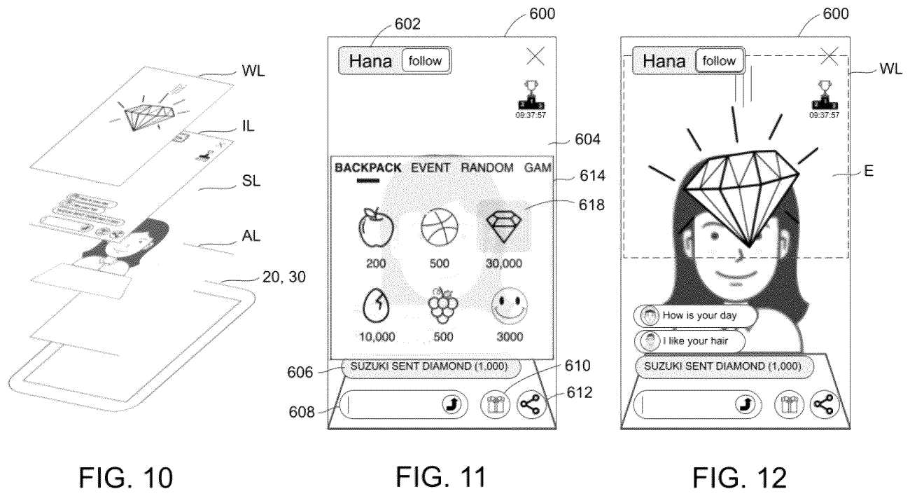

FIG. 10 is exemplary functional configuration of animation displaying according to some embodiments of subject application. As shown in FIG. 10, the screen 600 on user terminals 20 and 30 may include a plurality of layers such as application layer AL, streaming layer SL, interaction layer IL or the like. The application layer AL may be configured to provide communication services directly to the end-user or application. The application layer AL enables users to interact with the mobile device and perform specific tasks or functions, such as sending gifts or the like.

The streaming layer SL may be configured to provide the streaming data of multimedia content, such as audio and video, from the livestreamer. The streaming layer SL may buffer and decode streaming data from the network and ensure it is presented to the user at an appropriate rate. The interaction Layer IL may be configured to handle user interface interactions, including touch, gestures, button presses, and other forms of user input. The interaction Layer IL may capture and process user actions, translating them into corresponding software responses.

In some embodiments, the screen 600 may further include a Web View animation layer WL. The Web View animation layer WL may include a WebView object to display multimedia-related contents or the like. The native Web View provided by the native library in the platform enables the application to read the website. As shown in FIG. 10, when users are exposed to the animations, they are actually using this external component instead of the native animation player provided by the native library. All the playback states required for animation may be accomplished through the functions written in JavaScript or the like within the website, allowing users to continuously watch animations without interruption.

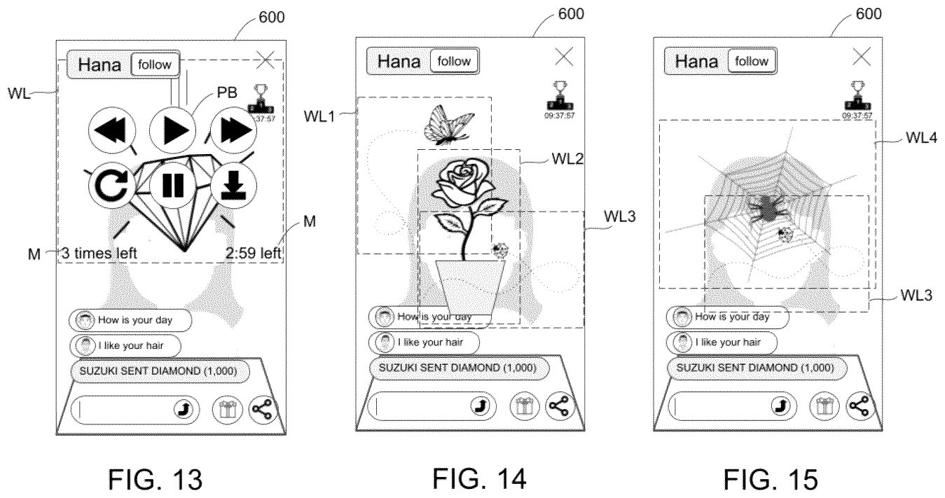

FIG. 11 and FIG. 15 are exemplary screen images of a live-streaming room screen 600 shown on the display of the livestreamer user terminal 20 or the viewer user terminal 30. FIG. 11 shows an exemplary screen image of a live-streaming room screen 600. Once the viewer selects and enters a live-streaming room, a live-streaming room screen 600 of the livestreamer may be shown on the display. The live streaming room screen 600 may include a livestreamer info object 602, livestreamer image 604, message zone 606, message input box 608, gift object 610, sharing object 612 or the like.

In some embodiments, the viewer may tap the gift object 610 and a gift list 614 may be displayed on the screen 600. The gift list 614 may include a plurality of gift 618, and the viewer may select a gift 618 to send to the streamer. As shown in FIG. 12, once the viewer clicks on the gift 618, an effect E of the gift 618 may be displayed on the screen 600. In some embodiments, the effect E may be displayed via video player embedded in the Web View animation layer WL on the screen 600. In some embodiments, the video player may include basic video-playing functions such as play, stop, replay or the like.

In some embodiments, effects of the gift may be operated by the livestreamer or the viewers. For example, the viewer may preview the effect of the gift by rewind, fast forward or replay the effect of the gift as shown in FIG. 13. The livestreamer may review the effect of the gift or the like. In some embodiments, the viewer may preview the effect of the gift before sending the gift and the livestreamer may review the effect of the gift after receiving the gift.

In some embodiments, display of effect of the gift may also be triggered by the livestreamer. For example, once the livestreamer receives a gift, a play button PB may be shown on effect of the gift as shown in FIG. 13 for the livestreamer to initiate the display. According to the embodiments, the livestreamer may feel that the gift is opened by him or her, and the user experience may be improved.

In some embodiments, the operation of effects by the users may be time-limited or within a specific number of times. For example, a message M showing the period or number of times of previewing or reviewing the effect may also be shown as FIG. 13. The livestreamer may operate the effect of the gift for a specific time or period. In some embodiments, the period or times of operation on the effects may be designed flexibly according to the practical need.

In some embodiments, one effect may be played in one Web View object. In some embodiments, one effect may be played in more than one Web View. In some embodiments, more than one effect may be played in one Web View object. In some embodiments, more than one effect may be played in more than one Web View. For example, an effect of a rose blooming and a butterfly flying around the rose may be displayed on screen 600 as shown in FIG. 14. The effect of the rose blooming and the butterfly flying may be displayed at the same Web View object or different Web View objects as shown in FIG. 14.

In some embodiments, the number, size and position of Web View objects may be determined and adjusted flexibly by the livestreamer or viewers. For example, the viewer who sends the gift of a rose and butterfly may determine the location of the rose and butterfly as shown in FIG. 14. In some embodiments, the direction or trajectory of the butterfly may also be determined and adjusted flexibly by the livestreamer or viewers.

In some embodiments, the html video player may be set in the Web View object and the effect of gift may be stored as multimedia-related contents to be played via the html video player. In some embodiments, if the viewer sends the same gift several times, the effect of the gift may be downloaded at first and then played for several times. According to the embodiment, the issue of caching may be avoided and the resource of the html object may be reused for several times. Therefore, the efficiency of displaying effects may be improved.

In some embodiments, the combination of rose and butterfly may be referred to as a combo gift. Here, the “combo gift” may refer to a special feature or interaction within a live streaming platform where viewers can send a combination of virtual gifts or digital items to the streamer or the like. In some embodiments, each portion of the combo gift may be displayed via the same or different Web View objects. In some embodiments, each portion of the combo gift may be sent by the same or different viewers.

In some embodiments, each effect of the gift may be separated into several sub-effects, or several effects of the gift may be combined into one effect. More specifically, the effect of gifts E1, E2 and E3 may be separated into the sub-effects of Ea+Eb, Eb+Ec and Ea+Ec respectively. The effects of Ea+Eb, Eb+Ec and Ea+Ec may also be combined into one the effects of E1, E2 and E3 respectively. For example, the effect of a rose blooming and a butterfly flying around the rose may be separated into a rose blooming and a butterfly flying respectively. In some embodiments, the effect of a rose blooming and a ladybug flying may be combined into one effect of the rose blooming and the ladybug flying around the rose. Therefore, if the effects Ea, Eb and Ec are downloaded and stored in the user terminal, not only the effects Ea, Eb and Ec also the effects of E1, E2 and E3 may also be played without further downloading.

In some embodiments, the processing unit 208 may request a portion of the gift if the rest portion of the gift is already requested and stored in the user terminal. For example, if an effect of the rose blooming and the ladybug flying around the rose is requested and stored in the user terminal as shown in FIG. 14, and the user would like to send another gift of a spider web with an ladybug flying around the web as shown in FG. 15, the processing unit 208 may request the portion of effect of the spider web only. According to the embodiments, the downloading of effects and the quality of displaying effects may be improved.

If a viewer sends a gift to a livestreamer in a live streaming room, the effect of the gift may be displayed on screens of the user terminals 30 of the viewer, the livestreamer and other viewers in the live streaming room. In some embodiments, the effect of the gift may be received and displayed on user terminals 20 of the livestreamer and viewer who sent the gift. The effect of gift may be rendered on the video of the livestreamer as streaming data, and then being pushed to the streaming server or the like. For the other viewers in the live streaming room, the streaming data may be pulled and then displayed on their user terminal 30 so that they may watch the effect of the gift on the screen of their terminal.

In some embodiments, if an effect or a portion of the effect of the gift is already sent by one viewer and the effect or the portion of the effect is already requested and stored in the user terminal 20 of the livestreamer, the effect may not be requested or only the rest portion of the gift need to be requested. According to the embodiments, the downloading of effects and the quality of displaying effects may be improved.

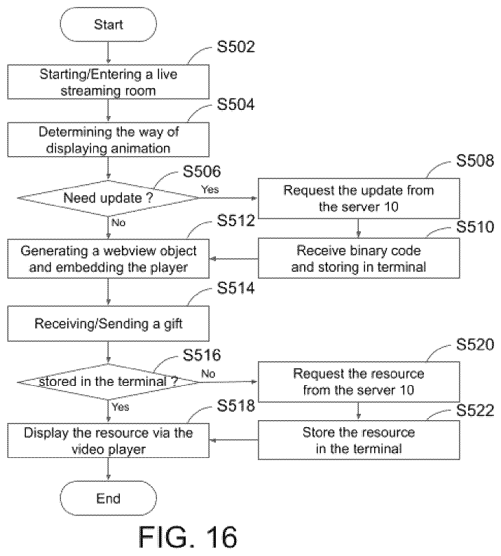

The operation of the live streaming system 1 with the above configuration will be now described. FIG. 16 is a flowchart showing steps of an application activation process on the user terminals 20 and 30. The livestreamer may start a live streaming room and the viewers may enter the live streaming room to interact with the livestreamer (S502).

Once the users are in the live streaming room, the way of displaying animation may be determined (S504). In some embodiments, the timing for determining the way of displaying animation may be flexible such as before the entrance of the live streaming room, when the user triggered or received a display of animation, when a Web View object is generated or the like. In some embodiments, the determination of animation display may be made by the server 10, the users or the like. For example, the server 10 may assign a video player or the user may select a video player for displaying an animation.

In some embodiments, the video player may need to be updated (S506). The update may be requested from the server 10 or initiated by the user or the like. In some embodiments, the purpose for updating the video player may be fixing the bugs of animation display, supporting new file types or the like. The user may determine to update or skip, and the server 10 may also request the user to update the video player if necessary.

If the update is not needed (No in S506), The processing unit 208 may generate a Web View object and embed a video player in the Web View object (S512). If the update is needed (Yes in S506), the update of the video player may be requested by the user terminal from the server 10 (S508). The server 10 may provide the user with the update of the video player voluntarily or in response to the request from the user. In some embodiments, the information of the video player may be provided in the format of binary code or the like.

Once receiving the binary code from server 10, the processing unit 208 may further store the information of the video player in the format of binary code in the user terminal (S510). The processing unit 208 may further generate a Web View on the screen of the user terminal and embed the video player in the Web View object (S512). In some embodiments, the binary code of the video player may be fed into the Web View object to establish a video player in the Web View object. The setting of the video player for displaying animation may be realized according to the above procedure.

Once the setting of the video player is done, the function of the animation display may be ready for displaying animation. In some embodiments, the viewers may send a gift to the livestreamers and the livestreamers may receive the gift from the viewers (S514). The processing unit 208 may check if the gift is already stored in the user terminal or not (S516). If the gift is stored in the user terminal (Yes in S516), the processing unit 208 may display the effect of the gift via the video player (S518).

If the gift is not stored in the user terminal (No in S516), the processing unit 208 may request the resource of the gift from server 10 (S520) or the like. In some embodiments, the user terminal may download the gift in advance. For example, some popular or daily gift may be downloaded when the user installs the APP or enters the live streaming. In some embodiments, the gift may be downloaded in response to the request from the user terminal of the user. For example, the user may click an icon of the gift to initiate a request to download the gift from the server 10.

In some embodiments, the processing unit 208 may further store the resource of the gift in the user terminal (S522) and further display the effect of the gift via the video player (S518). In contrast to caching the resource in a web page, the capacity for storing the gift resources may be significantly increased. Moreover, the gift resources may even be displayed offline even if there is no internet connection.

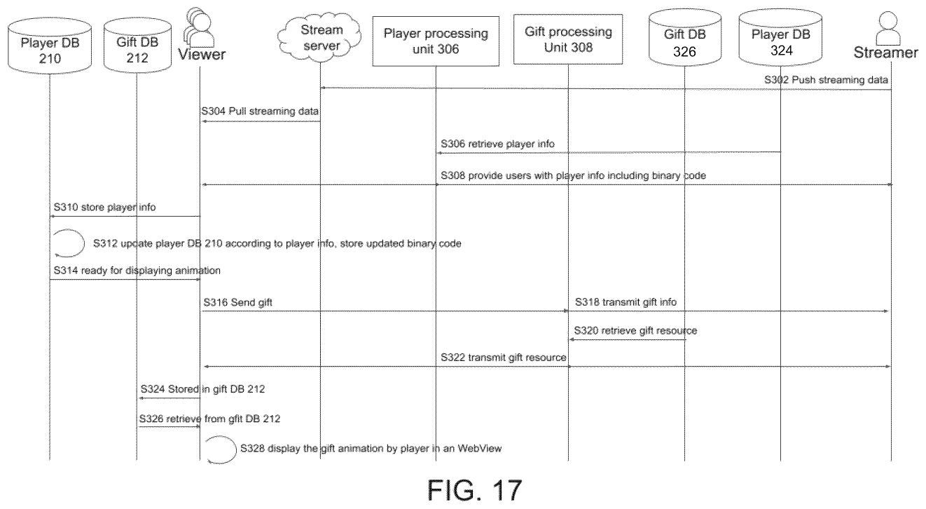

FIG. 17 is an exemplary sequence chart illustrating an operation of the configuration of the live streaming system 1 according to some embodiments of subject application. The livestreamer may upload the stream by pushing the streaming data to the stream server (S302). The viewer may select the stream to watch by pulling the streaming data to the user terminal of the user (S304).

Once a streaming room is established and the viewers enter the streaming room, the player processing unit 306 may retrieve information of the video player from the player DB 324 or the like (S306). The player processing unit 306 may further transmit the information of the video player to the livestreamer, viewers or the like (S308). In some embodiments, the information of the video player may include the file or update of the video player and the format of video player may be in the format of binary code or the like.

In some embodiments, the server 10 may encode the information of the video player in binary code. The binary code may include the information of the video player such as the version, description of the video player or the like. The binary code of video players may further be provided to the user terminal of the user.

Once the information of video players is received, it may be stored in the terminal side player DB 210 in the user terminal of the user (S310). In some embodiments, the processing unit 208 may determine whether to update the video player or not (S312). For example, the processing unit 208 may determine the update according to the binary code from the server 10. For example, the processing unit 208 may compare the binary code of the video player from the server 10 and from the terminal side player DB 210 to check if there is an update on the video player.

Once the video player is set, the user terminal may be ready for displaying animation such as the effect of the gift (S314). The viewers may send a gift to the livestreamer via the server 10 to support the performance (S316). The gift processing unit 308 may receive information of the gift and then further transmit it to the user terminal of the livestreamer (S318). In some embodiments, the gift processing unit 308 may also retrieve information of the gift resource from the gift DB 326 (S320) and further transmit information of the gift resource to the viewers, livestreamer or the like (S322).

In some embodiments, the gift processing unit 308 may retrieve information of the gift resource and transmit to the user in response to the request from the user. For example, the viewers may send a gift to the livestreamer. If there is no gift resource in the user terminal, a request on the gift resource may be transmitted to the server 10 for requesting the gift resource. In some embodiments, the gift processing unit 308 may also update the user DB 322, for example, by increasing or decreasing the point, level of the user or the like.

In some embodiments, the processing unit 208 in the user terminal may store the gift resource in the terminal side gift DB 212 (S324). More specifically, the processing unit 208 may store the information of the gift resource in the terminal side gift DB 212 and the effect data in a local storage in the user terminal. Once a gift is sent or received by a user, the processing unit 208 may retrieve effect data from the terminal side gift DB 212 (S326) and display the effect of the gift via the video player embedded in the Web View object (S328).

In some embodiments, if the gift is requested at the first time, the processing unit 208 may display the effect of the gift and then store the gift resource in the terminal side gift DB 212. If the gift resource is not requested at the first time and is already stored in the user terminal, the processing unit 208 may retrieve the gift resource from the terminal side gift DB 212 for display effect of the gift resource.

According to the above embodiments, the media components may be initialized dynamically and a systematic way of conducting media resources through the web may also be realized. It may also be possible to reduce the dependency on the internet when using media components. The above embodiments also provide a swift and easy way to deploy a pattern of media implementation structure. Moreover, updating the framework/media component to the user's local device can be bypassed from time consuming platform application processes. Therefore, the user experience may be improved.

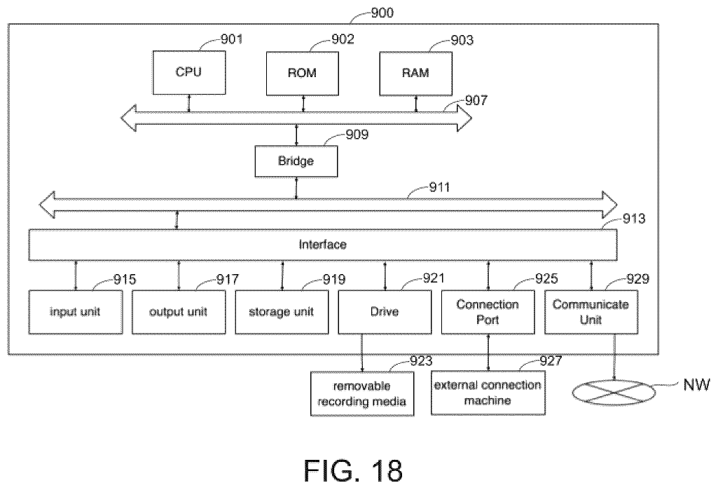

FIG. 18 is a schematic block diagram of computer hardware for carrying out a system configuration and processing according to some embodiments of subject application. The information processing device 900 in FIG. 18 is, for example, is configured to realize the server 10 and the user terminal 20 and 30 respectively according to some embodiments of subject application.

The information processing device 900 includes a CPU 901, read only memory (ROM) 902, and random-access memory (RAM) 903. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The CPU 901 is an example of hardware configuration to realize various functions performed by the components described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the streaming unit 100, the viewing unit 200, the video control unit 102, the audio control unit 104, the distribution unit 106, the UI control unit 108, the UI control unit 202, the rendering unit 204, the input transmit unit 206, the processing unit 208, the streaming info unit 302, the relay unit 304, the player processing unit 306, the gift processing unit 308, the stream DB 320, the user DB 322, the player DB 324, the gift DB 326, the terminal side player DB 210, the terminal side gift DB 212 and so on, may be embodied as circuitry programmed to realize such functions.

The CPU 901 functions as an arithmetic processing device and a control device, and controls the overall operation or a part of the operation of the information processing device 900 according to various programs recorded in the ROM 902, the RAM 903, the storage unit 919, or a removable recording medium 923. For example, the CPU 901 controls overall operations of respective function units included in the server 10 and the user terminal 20 and 30 of the above-described embodiment. The ROM 902 stores programs, operation parameters, and the like used by the CPU 901. The RAM 903 transiently stores programs used when the CPU 901 is executed, and parameters that change as appropriate when executing such programs. The CPU 901, the ROM 902, and the RAM 903 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 903. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal 30 of the viewer, the server, the user terminal 20 of the livestreamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

What is claimed is:

1. A method for displaying animation in a live streaming room, comprising:
generating a Web View object on a screen;
setting an animation player for displaying an animation in the Web View object;
providing the animation player with an animation resource; and
displaying an effect of the animation resource via the animation player.

2. The method according to claim 1, wherein:
the animation player is a html video player and is embedded in the Web View object via a binary code of the animation player.

3. The method according to claim 1, further comprising:
receiving information of the animation player from a server;
determining an update of the animation player according to the information; wherein
the information of the animation player is in format of binary code.

4. The method according to claim 3, wherein:
timing for determining the update is when a user enters the live streaming room, when the Web View object is generated or when the user sends a gift to a livestreamer.

5. The method according to claim 1, wherein:
the animation resource is a gift from a viewer sending to a livestreamer in the livestreaming room; and
the animation resource includes an effect to be displayed on the screen.

6. The method according to claim 1, further comprising:
requesting the animation resource from a server in response to there being no resource available in a user terminal; and
storing the animation resource in a local space of the user terminal.

7. The method according to claim 1, wherein:
timing of displaying the effect of the animation resource is determined by a user in response to an operation from the user.

8. The method according to claim 1, wherein:
setting the animation player includes feeding a binary code of the animation player to the Web View object to establish the animation player in the Web View object.

9. A terminal comprising a circuitry, wherein the circuitry is configured to perform:
generating a Web View object on a screen;
setting an animation player for displaying an animation in the Web View object,
providing the animation player with an animation resource; and
displaying an effect of the animation resource via the animation player.

10. A non-transitory computer-readable medium including program instructions, that when executed by one or more processors, cause the one or more processors to execute:
generating a Web View object on a screen;
setting an animation player for displaying an animation in the Web View object;
providing the animation player with an animation resource; and
displaying an effect of the animation resource via the animation player.
